(19) United States
(12) Patent Application Publication
(10) Pub. No.: US 2025/0192557 A1
(43) Pub. Date: Jun. 12, 2025

(54) SYSTEM AND METHOD FOR MITIGATING SUB-SYNCHRONOUS OSCILLATIONS IN AN INVERTER-BASED RESOURCE

(71) Applicant: General Electric Renovables Espana S.L., Barcelona (ES)

(72) Inventors: Rabisankar Roy, Bengaluru (IN); Veena Padmarao, Bengaluru (IN); Subbarao Tatikonda, Bengaluru (IN); Rupam Basak, Howrah (IN); Arvind Kumar Tiwari, Niskayuna, NY (US)

(21) Appl. No.: 18/845,477

(22) PCT Filed: Mar. 15, 2022
(86) PCT No.: PCT/US2022/020339

§ 371 Date: Sep. 10, 2024

(51) Int. Cl. H02J 3/24; H02P 9/02

(52) U.S. Cl. CPC H02J 3/241; H02P 9/02

(57) ABSTRACT

A method for mitigating sub-synchronous power oscillations in an inverter-based resource connected to an electrical grid via a series-compensated grid connection includes determining, via a controller, one or more rotor current commands for a power converter of the inverter-based resource. The method also includes applying, via a software module of the controller, at least one stator current component to the one or more rotor current commands to provide active damping to mitigate the sub-synchronous power oscillations in the inverter-based resource. Further, the method includes determining, via the controller, at least one voltage command for the inverter-based resource as a function of the one or more rotor current commands and the at least one stator current component. Moreover, the method includes controlling, via the controller, the inverter-based resource, based at least in part, on the voltage command.

### FIELD

The present disclosure relates generally to inverter-based resources, such as wind turbine power systems and, more particularly, to systems and methods for mitigating sub-synchronous oscillations in grid-forming and grid-following inverter-based resources connected to a series-compensated network.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms. However, with the rapid growth of the wind power, wind power penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control.

Many existing renewable generation converters, such as double-fed wind turbine generators, operate in a “grid-following” mode. Grid-following type devices utilize fast current-regulation loops to control active and reactive power exchanged with the grid. More specifically, FIG. 1 illustrates the basic elements of the main circuit and converter control structure for a grid-following double-fed wind turbine generator. As shown, the active power reference to the converter is developed by the energy source regulator, e.g., the turbine control portion of a wind turbine. This is conveyed as a torque reference which represents the lesser of the maximum attainable power from the energy source at that instant, or a curtailment command from a higher-level grid controller. The converter control then determines a current reference for the active component of current to achieve the desired torque. Accordingly, the double-fed wind turbine generator includes functions that manage the voltage and reactive power in a manner that results in a command for the reactive component of current. Wide-bandwidth current regulators then develop commands for voltage to be applied by the converters to the system, such that the actual currents closely track the commands.

Alternatively, grid-forming type converters provide a voltage-source characteristic, where the angle and magnitude of the voltage are controlled to achieve the regulation functions needed by the grid. With this structure, current will flow according to the demands of the grid while the converter contributes to establishing a voltage and frequency for the grid. This characteristic is comparable to conventional generators based on a turbine driving a synchronous machine. Thus, a grid-forming source must include the following basic functions: (1) support grid voltage and frequency for any current flow within the rating of the equipment, both real and reactive: (2) prevent operation beyond equipment voltage or current capability by allowing grid voltage or frequency to change rather than disconnecting equipment (disconnection is allowed only when voltage or frequency are outside of bounds established by the grid entity): (3) remain stable for any grid configuration or load characteristic, including serving an isolated load or connected with other grid-forming sources, and switching between such configurations: (4) share total load of the grid among other grid-forming sources connected to the grid: (5) ride through grid disturbances, both major and minor, and (6) meet requirements (1)-(5) without requiring fast communication with other control systems existing in the grid, or externally-created logic signals related to grid configuration changes.

The basic control structure to achieve the above grid-forming objectives was developed and field-proven for battery systems in the early 1990's (see e.g., U.S. Pat. No. 5,798,633 entitled “Battery Energy Storage Power Conditioning System”). Applications to full-converter wind generators and solar generators are disclosed in U.S. Pat. No. 7,804,184 entitled “System and Method for Control of a Grid Connected Power Generating System,” and U.S. Pat. No. 9,270,194 entitled “Controller for controlling a power converter.” Applications to grid-forming control for a doubly-fed wind turbine generator are disclosed in PCT/US2020/013787 entitled “System and Method for Providing Grid-Forming Control for a Doubly-Feb Wind Turbine Generator.”

To be effective, grid-forming (GFM) inverter-based resources (IBRs) must be able to maintain an internal voltage phasor that does not move quickly when there are changes in grid conditions, e.g., sudden addition/removal of loads, opening or closing of grid connections that lead to phase jumps and/or rapid change of frequency. In other words, the power from the grid-forming resource must be able to change suddenly to stabilize the grid, with a subsequent slow reset to power being commanded from a higher-level control function. In addition, the grid-forming resource must be able to rapidly enforce power limits that exist due to constraints on the power-handling portions of the device, e.g., DC voltages/currents in a battery, solar array, and/or wind generating system. Such a response is needed for severe disturbances on the grid, e.g., faults where power limits will be dynamically adjusted to coordinate with grid conditions for secure recovery from the fault. Further, the grid-forming resource should be able to rapidly follow changes in commands from higher-level controls, e.g., for damping mechanical vibrations in a wind turbine. Such requirements, however, can be difficult to achieve.

In addition, at least some known electric utility grids include one or more series-compensated transmission lines. Doubly-fed induction generator (DFIG) wind turbines connected to series compensated transmission lines are susceptible to sub-synchronous oscillations. Thus, in certain instances, control systems associated with DFIG wind turbines can present a negative resistance to the grid under sub-synchronous conditions. This is primarily caused by the high band-width rotor current control loop, which increases the effective rotor side resistance. The undesirable sub-synchronous active power oscillation can lead to instability in the system and equipment damage. This sub-synchronous phenomena, in which grid, DFIG, power converters and control loops are involved, can effectively disconnect the wind turbine from the grid.

In view of the foregoing, an improved system and method that addresses the aforementioned issues would be welcomed in the art. Accordingly, the present disclosure is directed to systems and methods for mitigating sub-synchronous power oscillations in grid-forming and grid-following inverter-based resources connected to a series-compensated network.

### BRIEF DESCRIPTION

Aspects and advantages of the invention will be set forth in part in the following description, or may be obvious from the description, or may be learned through practice of the invention.

In one aspect, the present disclosure is directed to a method for mitigating sub-synchronous power oscillations in an inverter-based resource connected to an electrical grid via a series-compensated grid connection. The inverter-based resource has a power converter and a generator. The method includes determining, via a controller, one or more rotor current commands for the power converter. The method also includes applying, via a software module of the controller, at least one stator current component to the one or more rotor current commands to provide active damping to mitigate the sub-synchronous power oscillations in the inverter-based resource. Further, the method includes determining, via the controller, at least one voltage command for the inverter-based resource as a function of the one or more rotor current commands and the at least one stator current component. Moreover, the method includes controlling, via the controller, the inverter-based resource, based at least in part, on the voltage command. It should be understood that the method may further include any of the additional features and/or steps described herein.

In another aspect, the present disclosure is directed to a method for mitigating sub-synchronous power oscillations in an inverter-based resource connected to an electrical grid via a series-compensated grid connection. The inverter-based resource has a power converter and a generator. The method includes receiving, via a controller, an indication that the generator is experiencing a negative resistance a under sub-synchronous condition. Further, the method includes compensating, via the controller, the negative resistance the under sub-synchronous condition by reducing an effective rotor resistance, wherein reducing the effective rotor resistance is achieved by placing a virtual resistance in parallel to the effective rotor resistance. It should be understood that the method may further include any of the additional features and/or steps described herein.

In yet another aspect, the present disclosure is directed to a converter controller for mitigating sub-synchronous power oscillations in an inverter-based resource connected to an electrical grid via a series-compensated grid connection. The inverter-based resource has a power converter and a generator. The converter controller includes at least one controller having at least one processor. The processor(s) is configured to perform a plurality of operations, including but not limited to determining one or more rotor current commands for the power converter, applying at least one stator current component to the one or more rotor current commands to provide active damping to mitigate the sub-synchronous power oscillations in the inverter-based resource, determining at least one voltage command for the inverter-based resource as a function of the one or more rotor current commands and the at least one stator current component, and controlling the inverter-based resource, based at least in part, on the voltage command. It should be understood that the converter controller may further include any of the additional features and/or steps described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a one-line diagram of a double-fed wind turbine generator with structure of converter controls for grid-following application according to conventional construction;

FIG. 2 illustrates a perspective view of one embodiment of a wind turbine according to the present disclosure;

FIG. 3 illustrates a simplified, internal view of one embodiment of a nacelle according to the present disclosure;

FIG. 4 illustrates a schematic view of one embodiment of a wind turbine electrical power system suitable for use with the wind turbine shown in FIG. 1;

FIG. 5 illustrates a schematic view of one embodiment of a wind farm having a plurality of wind turbines according to the present disclosure;

FIG. 6 illustrates a block diagram of one embodiment of a controller according to the present disclosure;

FIG. 7 illustrates a one-line diagram of a double-fed wind turbine generator with converter controls for grid-forming application according to the present disclosure;

FIG. 8 illustrates a one-line system diagram of the system for providing grid-forming control of a double-fed generator of a wind turbine according to the present disclosure;

FIG. 9 illustrates a simplified grid-forming control loop block diagram of the system according to the present disclosure;

FIG. 10 illustrates a grid-forming control loop diagram of the system according to the present disclosure, particularly illustrating a voltage control loop and a frequency control loop;

FIG. 11 illustrates a flow diagram of one embodiment of method for mitigating sub-synchronous power oscillations in an inverter-based resource connected to an electrical grid via a series-compensated grid connection according to the present disclosure;

FIG. 12 illustrates an equivalent circuit diagram of a dual-fed induction generator for mitigating sub-synchronous power oscillations in an inverter-based resource connected to an electrical grid via a series-compensated grid connection according to the present disclosure;

FIG. 13 illustrates an embodiment of an approach to compensate the negative R_{eq} (Rᵣ) by placing a parallel resistance Rₓ such that the effect of R_{eq} can be reduced and the systems overall resistance (considering stator and network resistances) becomes positive according to the present disclosure;

FIG. 14 illustrates a schematic diagram of an embodiment of a damping control loop for a grid-forming mode of an inverter-based resource according to the present disclosure;

FIG. 15 illustrates a schematic diagram of an embodiment of a damping control loop for a grid-forming mode of an inverter-based resource according to the present disclosure;

FIG. 16 illustrates a schematic diagram of an embodiment of a damping control loop for a grid-forming mode being applied to a power converter of an inverter-based resource according to the present disclosure;

FIG. 17 illustrates a schematic diagram of another embodiment of a damping control loop for a grid-forming mode of an inverter-based resource according to the present disclosure;

FIG. 18 illustrates a schematic diagram of another embodiment of a damping control loop for a grid-forming mode being applied to a power converter of an inverter-based resource according to the present disclosure;

FIG. 19 illustrates a schematic diagram of an embodiment of a damping control loop for a grid-forming mode of an inverter-based resource according to the present disclosure;

FIG. 20 illustrates a schematic diagram of an embodiment of a grid-following mode of an inverter-based resource according to the present disclosure;

FIG. 21 illustrates a schematic diagram of an embodiment of a grid-following mode being applied to a power converter of an inverter-based resource according to the present disclosure;

FIG. 22 illustrates a schematic diagram of an embodiment of a damping control loop for a grid-following mode of an inverter-based resource according to the present disclosure;

FIG. 23 illustrates a schematic diagram of another embodiment of a damping control loop for a grid-following mode being applied to a power converter of an inverter-based resource according to the present disclosure; and

FIG. 24 illustrates a flow diagram of one embodiment of method for mitigating sub-synchronous power oscillations in an inverter-based resource connected to an electrical grid via a series-compensated grid connection according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to systems and methods for mitigating sub-synchronous power oscillations in grid-forming and grid-following inverter-based resources connected to a series-compensated network. In particular, the negative resistance presented by the DFIG wind turbine under sub-synchronous conditions can be compensated by reducing the effective rotor resistance. This is achieved by placing a virtual resistance in parallel to the effective rotor resistance. The grid forming control for a wind turbine is designed with two outer loops, voltage, and frequency loops. However, at times, the frequency loop may fail to mitigate the oscillations due to series compensation if the loop bandwidth is kept low. Even with a higher bandwidth frequency loop, the sub-synchronous oscillations become prominent when the active power command gets saturated to its maximum value. Whereas a grid following controlled wind turbine does not have any frequency regulation loop, thus it shows oscillations when the magnitude of equivalent rotor resistance under sub-synchronous conditions exceed the sum of stator and network resistances. As such, the present disclosure is configured to mitigate the oscillations by providing active damping via adding filtered and amplified stator currents to the rotor current commands on both d and q components.

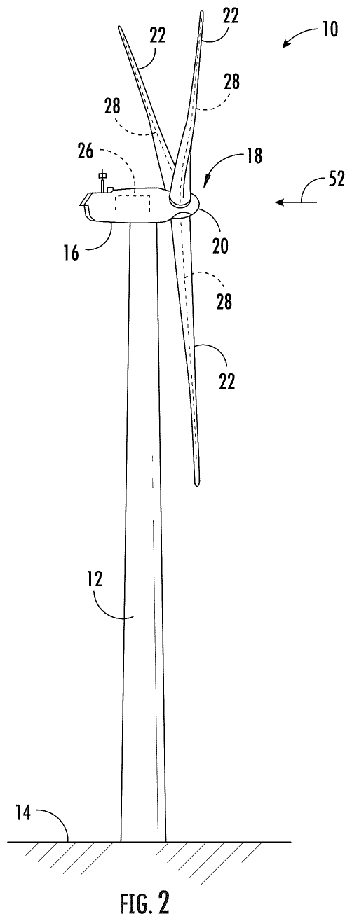

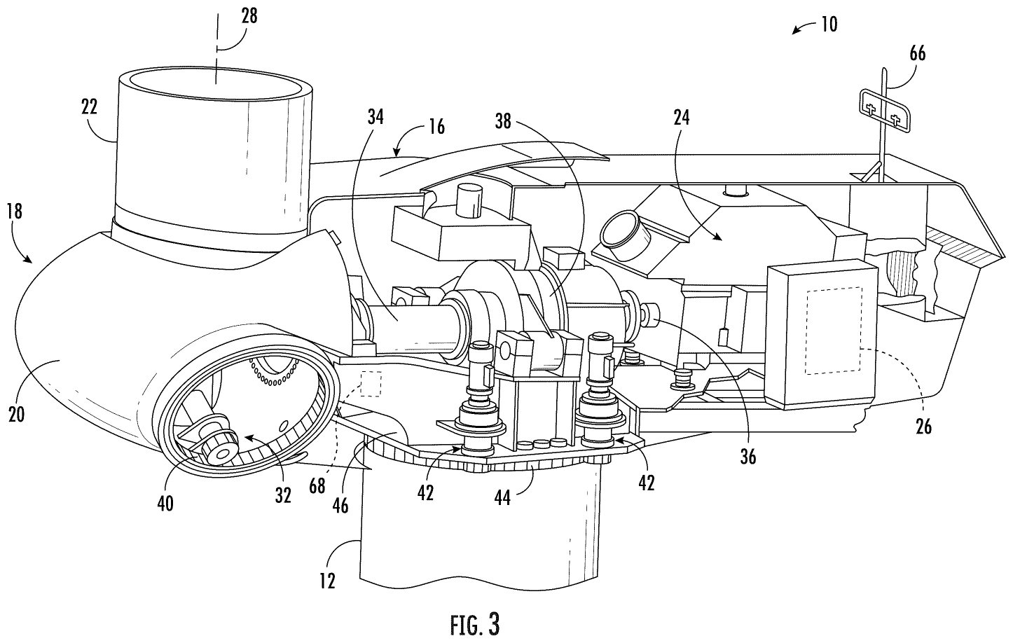

Referring now to the drawings, FIG. 2 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 3) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

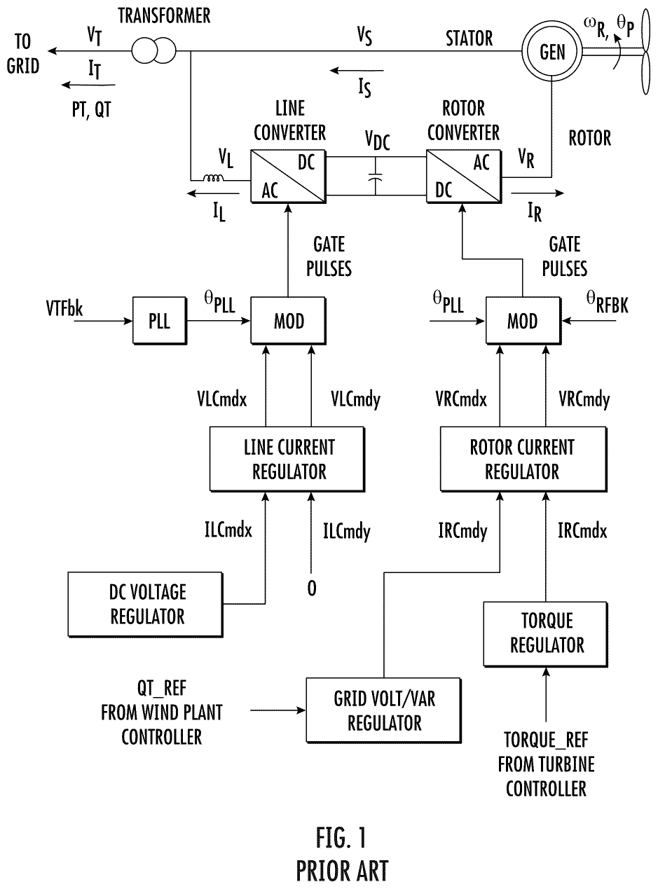

Referring now to FIG. 2, a simplified, internal view of one embodiment of the nacelle 16 of the wind turbine 10 shown in FIG. 1 is illustrated. As shown, a generator 24 may be disposed within the nacelle 16 and supported atop a bedplate 46. In general, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

The wind turbine 10 may also one or more pitch drive mechanisms 32 communicatively coupled to the wind turbine controller 26, with each pitch adjustment mechanism(s) 32 being configured to rotate a pitch bearing 40 and thus the individual rotor blade(s) 22 about its respective pitch axis 28. In addition, as shown, the wind turbine 10 may include one or more yaw drive mechanisms 42 configured to change the angle of the nacelle 16 relative to the wind (e.g., by engaging a yaw bearing 44 of the wind turbine 10 that is arranged between the nacelle 16 and the tower 12 of the wind turbine 10).

In addition, the wind turbine 10 may also include one or more sensors 66, 68 for monitoring various wind conditions of the wind turbine 10. For example, the incoming wind direction 52, wind speed, or any other suitable wind condition near of the wind turbine 10 may be measured, such as through use of a suitable weather sensor 66. Suitable weather sensors may include, for example, Sonic Detection and Ranging (“SODAR”) devices, anemometers, wind vanes, barometers, or any other sensing device which can provide wind directional information now known or later developed in the art. Still further sensors 68 may be utilized to measure additional operating parameters of the wind turbine 10, such as voltage, current, vibration, etc. as described herein.

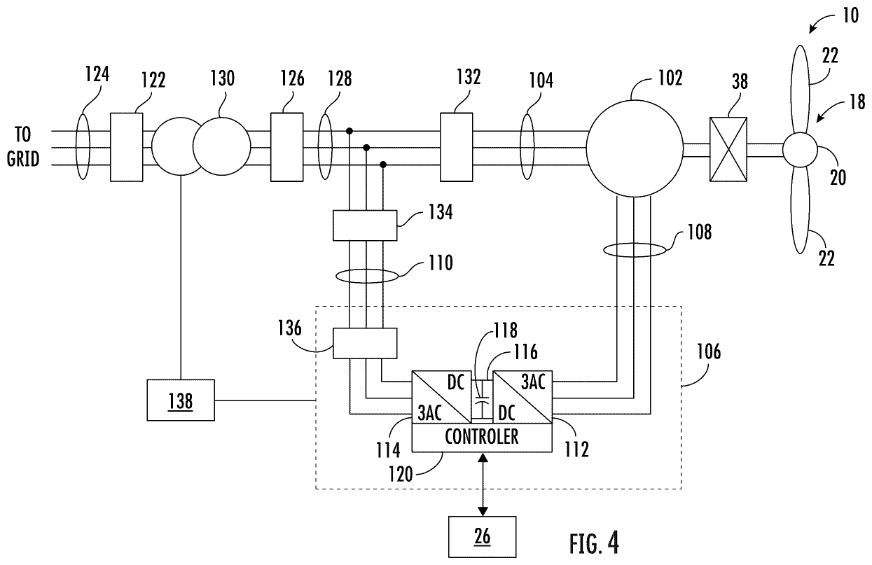

Referring now to FIG. 4, a schematic diagram of one embodiment of a wind turbine power system 100 is illustrated in accordance with aspects of the present disclosure. Although the present disclosure will generally be described herein with reference to the system 100 shown in FIG. 4, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 4 and as mentioned, the rotor 18 of the wind turbine 10 (FIG. 2) may, optionally, be coupled to the gearbox 38, which is, in turn, coupled to a generator 102, which may be a doubly fed induction generator (DFIG). As shown, the DFIG 102 may be connected to a stator bus 104. Further, as shown, a power converter 106 may be connected to the DFIG 102 via a rotor bus 108, and to the stator bus 104 via a line side bus 110. As such, the stator bus 104 may provide an output multiphase power (e.g., three-phase power) from a stator of the DFIG 102, and the rotor bus 108 may provide an output multiphase power (e.g., three-phase power) from a rotor of the DFIG 102. The power converter 106 may also include a rotor side converter (RSC) 112 and a line side converter (LSC) 114. The DFIG 102 is coupled via the rotor bus 108 to the rotor side converter 112. Additionally, the RSC 112 is coupled to the LSC 114 via a DC link 116 across which is a DC link capacitor 118. The LSC 114 is, in turn, coupled to the line side bus 110.

The RSC 112 and the LSC 114 may be configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor side converter 112 and/or the line side converter 114 as described herein. It should be noted that the converter controller 120 may be configured as an interface between the power converter 106 and the turbine controller 26 and may include any number of control devices.

In typical configurations, various line contactors and circuit breakers including, for example, a grid breaker 122 may also be included for isolating the various components as necessary for normal operation of the DFIG 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the DFIG 102 by rotating the rotor 18 is provided to the electrical grid 124 via dual paths defined by the stator bus 104 and the rotor bus 108. On the rotor bus side 108, sinusoidal multi-phase (e.g., three-phase) alternating current (AC) power is provided to the power converter 106. The rotor side converter 112 converts the AC power provided from the rotor bus 108 into direct current (DC) power and provides the DC power to the DC link 116. As is generally understood, switching elements (e.g., IGBTs) used in the bridge circuits of the rotor side converter 112 may be modulated to convert the AC power provided from the rotor bus 108 into DC power suitable for the DC link 116.

In addition, the line side converter 114 converts the DC power on the DC link 116 into AC output power suitable for the electrical grid 124. In particular, switching elements (e.g., IGBTs) used in bridge circuits of the line side converter 114 can be modulated to convert the DC power on the DC link 116 into AC power on the line side bus 110. The AC power from the power converter 106 can be combined with the power from the stator of DFIG 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, the local control system 176 via the converter controller 120. The control signals may be based, among other things, on sensed states or operating characteristics of the wind turbine power system 100. Typically, the control signals provide for control of the operation of the power converter 106. For example, feedback in the form of a sensed speed of the DFIG 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

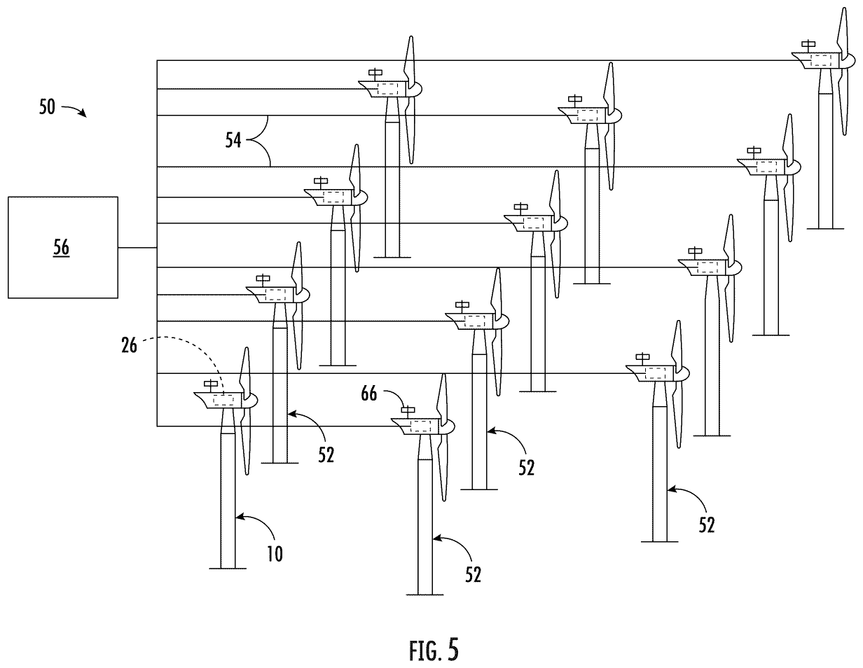

Referring now to FIG. 5, the wind turbine power system 100 described herein may be part of a wind farm 50. As shown, the wind farm 50 may include a plurality of wind turbines 52, including the wind turbine 10 described above, and an overall farm-level controller 56. For example, as shown in the illustrated embodiment, the wind farm 50 includes twelve wind turbines, including wind turbine 10. However, in other embodiments, the wind farm 50 may include any other number of wind turbines, such as less than twelve wind turbines or greater than twelve wind turbines. In one embodiment, the turbine controllers of the plurality of wind turbines 52 are communicatively coupled to the farm-level controller 56, e.g., through a wired connection, such as by connecting the turbine controller 26 through suitable communicative links 54 (e.g., a suitable cable). Alternatively, the turbine controllers may be communicatively coupled to the farm-level controller 56 through a wireless connection, such as by using any suitable wireless communications protocol known in the art. In further embodiments, the farm-level controller 56 is configured to send and receive control signals to and from the various wind turbines 52, such as for example, distributing real and/or reactive power demands across the wind turbines 52 of the wind farm 50.

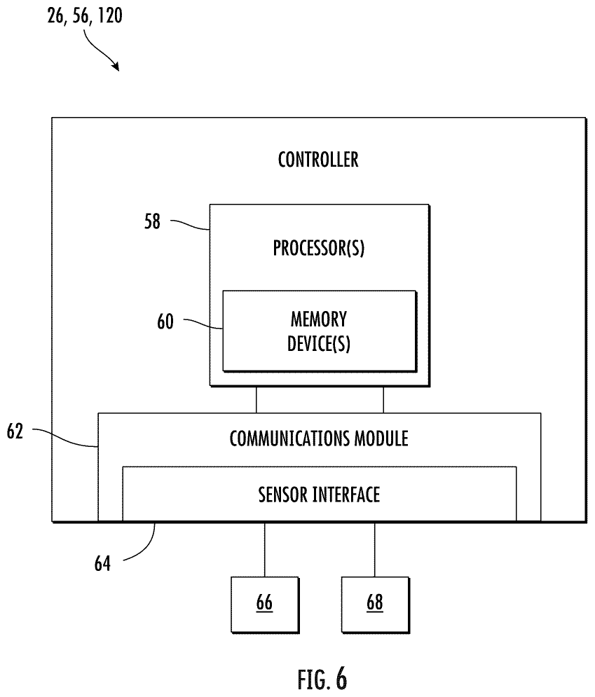

Referring now to FIG. 6, a block diagram of one embodiment of suitable components that may be included within the controller (such as any one of the converter controller 120, the turbine controller 26, and/or the farm-level controller 56 described herein) in accordance with example aspects of the present disclosure is illustrated. As shown, the controller may include one or more processor(s) 58, computer, or other suitable processing unit and associated memory device(s) 60 that may include suitable computer-readable instructions that, when implemented, configure the controller to perform various different functions, such as receiving, transmitting and/or executing wind turbine control signals (e.g., performing the methods, steps, calculations and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 60 may generally be configured to store suitable computer-readable instructions that, when implemented by the processor(s) 58, configure the controller to perform various functions as described herein. Additionally, the controller may also include a communications interface 62 to facilitate communications between the controller and the various components of the wind turbine 10. An interface can include one or more circuits, terminals, pins, contacts, conductors, or other components for sending and receiving control signals. Moreover, the controller may include a sensor interface 64 (e.g., one or more analog-to-digital converters) to permit signals transmitted from the sensors 66, 68 to be converted into signals that can be understood and processed by the processor(s) 58.

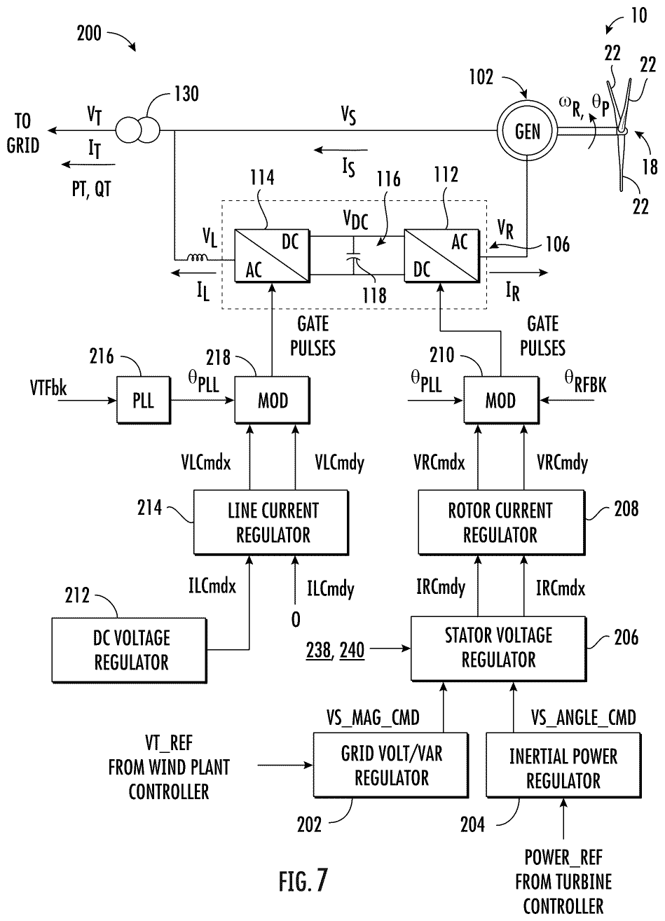

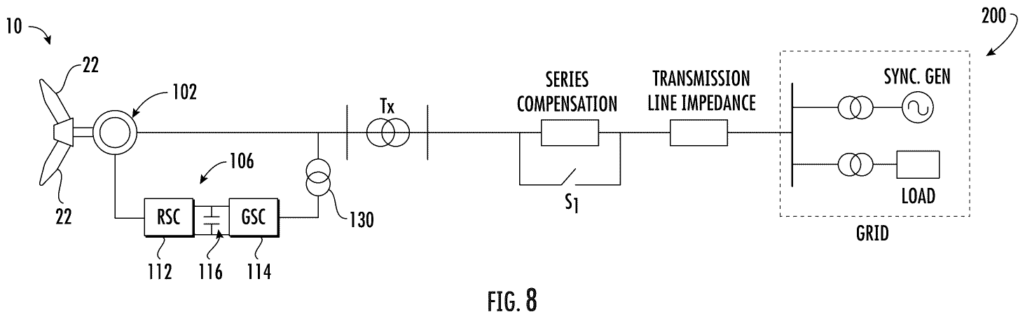

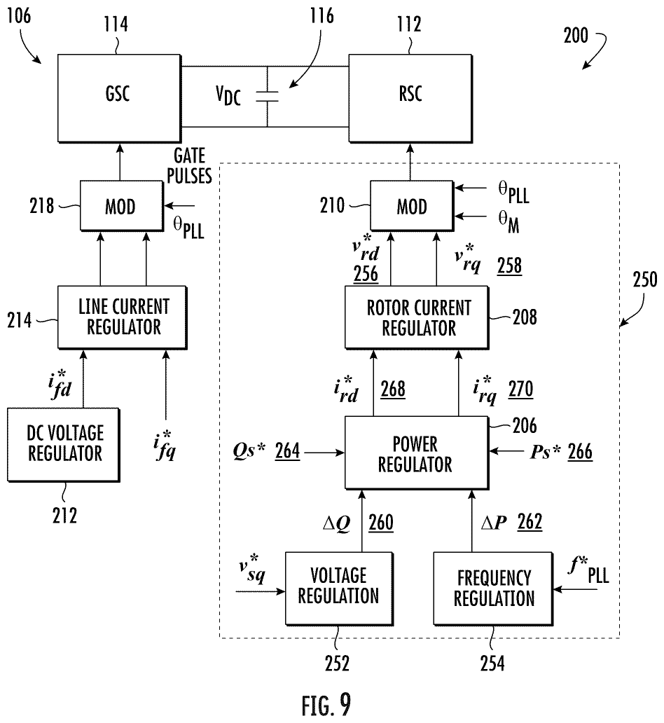

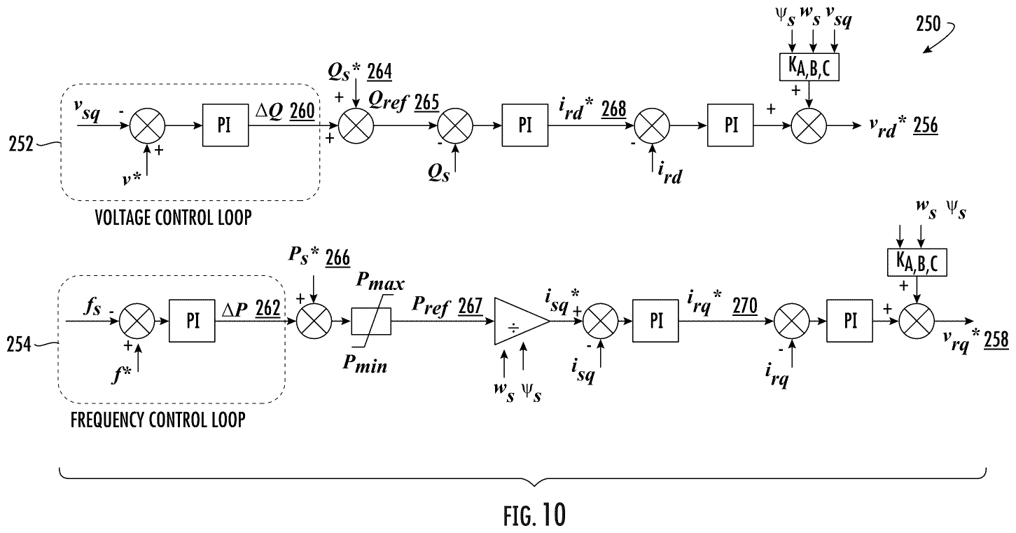

Referring now to FIGS. 7-10, various diagrams for providing grid-forming control of a double-fed generator of a wind turbine according to the present disclosure are illustrated. In particular, FIG. 7 illustrates a schematic diagram of one embodiment of a system 200 for providing grid-forming control of a double-fed generator of a wind turbine according to the present disclosure, particularly illustrating a one-line diagram of the DFIG 102 with a high-level control structure for grid-forming characteristics. FIG. 8 illustrates a one-line system diagram of the system 200 for providing grid-forming control of a double-fed generator of a wind turbine according to the present disclosure. FIG. 9 illustrates a simplified grid-forming control loop block diagram of the system 200 according to the present disclosure. FIG. 10 illustrates a grid-forming control loop diagram of the system 200 according to the present disclosure, particularly illustrating a voltage control loop and a frequency control loop.

Referring particularly to FIGS. 7-9, the system 200 may include many of the same features of FIG. 4 described herein, with components having the same reference characters representing like components. Further, as shown, the system 200 may include a control structure for controlling the line-side converter that is similar to the control structure shown in FIG. 1. More particularly, as shown, the line-side converter control structure may include a DC voltage regulator 212 and a line current regulator 214. As such, the DC voltage regulator 212 is configured to generate line-side current commands (e.g., ILCmdx) for the line current regulator 214. The line current regulator 214 then generates line-side voltage commands (e.g., VLCmdx, VLCmdy) for a modulator 218. The modulator 218 also receives an output (e.g., a phase-locked loop angle, θ_{PLL}) from a phase-locked loop 216 to generate one or more gate pulses for the line-side converter 114. The phase-locked loop 216 typically generates its output using a voltage feedback signal.

Furthermore, as shown, the system 200 may also include a unique control structure for controlling the rotor-side converter 112 using grid-forming characteristics. In particular, as shown in FIG. 7, the system 200 may include a stator voltage regulator 206 for providing such grid-forming characteristics. In addition, as shown, the system 200 may include a grid voltage/VAR regulator 202, an inertial power regulator 204, a rotor current regulator 208, and a modulator 210. Thus, in an embodiment, as shown, the system 200 is configured to determine voltage command(s) (e.g., VS_MAG_Cmd and VS_ANGLE_Cmd) via the voltage/VAR regulator 202 and/or the inertial power regulator 204 using, e.g., one or more reference commands from an external controller. In such embodiment, the external controller may include, for example, the turbine controller 26 of the wind turbine 10 or the farm-level controller 56 of the wind farm 50. Moreover, as shown, the reference command(s) may include at least one of a voltage reference (e.g., VT_Ref) or VAR reference from the farm-level controller 56 and/or a power reference (e.g., Power_Ref) from the turbine controller 26.

Referring to FIG. 7, the stator voltage regulator 206 of the system 200 is configured to determine one or more rotor current commands (e.g., IRCmdy and IRCmdx) as a function of a magnetizing current command 238 and/or a stator current feedback signal 240 of the DFIG 102. Thus, the output(s) (e.g., rotor current commands IRCmdy, IPCmdx) from the stator voltage regulator 206 can be implemented in the rotor current regulator 208 by generating rotor voltage commands (e.g., VRCmdx and VRCmdy) for a modulator 210. The modulator 210 also receives the phase-locked loop angle from the phase-locked loop 216 and a reference angle (e.g., θ_{FFBK}) to generate one or more gate pulses for the rotor-side converter 112.

Referring particularly to FIGS. 9 and 10 and as mentioned, the grid-forming control scheme 250 includes a voltage-frequency control strategy to operate the DFIG 102 in a grid forming mode (GFM), where v* and f* are the instantaneous voltage and frequency references along the direction of PCC space vector, Qs* and Qs are the reference reactive power and feedback reactive power, ΔQ and ΔP are the output of voltage and frequency regulation loop, Ps* is the active power command, Pmax and Pmin are the maximum and minimum limit on active power command, T*ₑₘ is the torque command, i_{rd}*, i_{rd} are the d components of rotor current command and feedback, i_{rq}*, i_{rd} are the d component of rotor current command and feedback, ψs is the stator flux, or is the rotor angular frequency, and v_{rd}*, v_{rq}* are the d, q components of rotor voltage command.

As shown, the GFM control 250 is based on a reference system derived from the instantaneous point of common coupling (PCC) dynamics. An instantaneous reference space vector is established along the direction of PCC space vector. Thus, the deviations of the PCC space vector (in terms of magnitude and angular speed) with respect to the reference space vector are controlled via GFM loops. For example, as shown, a voltage control loop 252 generates a d-component of rotor voltage (v_{rd}*) 256 and a frequency control loop 254 generates a q-component of rotor voltage (v_{rq}*) 258. More specifically, the voltage control loop 252 generates a delta reactive power value ΔQ 260 as a function of v_{sq} and v*. Similarly, the frequency control loop 254 generates a delta active power value ΔP 262 as a function of fs and f*. Thus, as shown, the voltage control loop 252 generates a reactive power reference Q_{ref} 265 as a function of Qs* 264 and the delta reactive power value ΔQ 260. Similarly, the frequency control loop 254 generates an active power reference P_{ref} 267 as a function of Ps* 266 and the delta active power value ΔP 262. Accordingly, the voltage and frequency control loops 252, 254 are each configured to generate d- and q-components of the rotor current commands 268, 270 (i_{rd}*, i_{rq}*). Thus, as shown, the d- and q-components of the rotor current commands 268, 270 (i_{rd}*, i_{rq}*) are then used to generate the d-component of rotor voltage (v_{rd}*) 256 and the q-component of rotor voltage (v_{rq}*) 258, respectively.

Series capacitors are often installed in long-distance AC transmission lines to boost the power transfer capability of the lines. The series capacitor creates a resonant circuit, which may interact with the converter controls of power electronics. Dual-fed wind turbines, such as those illustrated in FIG. 7, can be susceptible to this type of interaction. If not properly damped, the oscillations can be unstable and lead to trips of the wind farm 50. Thus, systems and methods of the present disclosure are directed to mitigating sub-synchronous power oscillations in an inverter-based resource connected to an electrical grid via a series-compensated grid connection, such as the structures/diagrams illustrated in FIGS. 7-9.

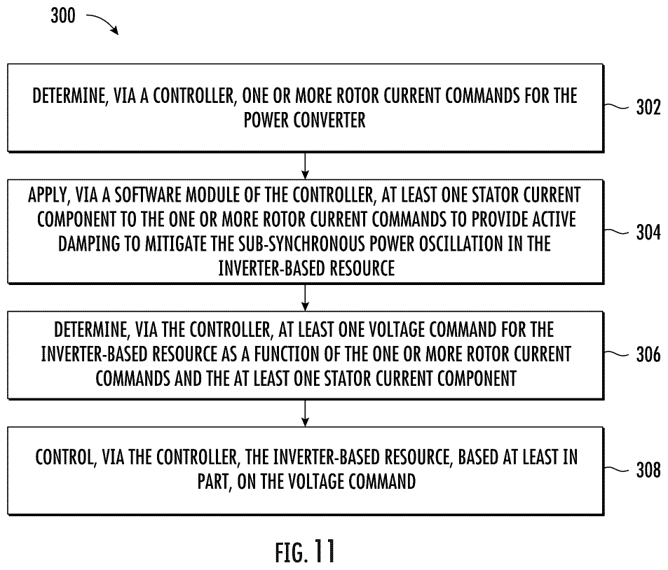

In particular, and referring now to FIG. 11, a flow diagram of one embodiment of the method 300 for mitigating sub-synchronous power oscillations in an inverter-based resource connected to an electrical grid via a series-compensated grid connection is provided. The inverter-based resource as described herein may include, for example, a wind turbine power system, a solar power system, an energy storage power system, or combinations thereof. In general, the method 300 is described herein with reference to the wind turbine 10 of FIGS. 2-10. However, it should be appreciated that the disclosed method 300 may be implemented with wind turbines having any other suitable configurations. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (302), the method 300 includes determining, via a controller, one or more rotor current commands for the power converter. In such embodiments, the controller may be a turbine controller, a converter controller, or any other suitable controller that is part of or separate from the inverter-based resource.

As shown at (304), the method 300 includes applying, via a software module of the controller, at least one stator current component to the rotor current command(s) to provide active damping to mitigate the sub-synchronous power oscillations in the inverter-based resource. In an embodiment, for example, applying the stator current component(s) to the rotor current command(s) may include applying a d-component stator current component and a q-component stator current component to d- and q-components of the rotor current command(s), respectively. In such embodiments, the stator current component(s) may include the d-component stator current component and the q-component stator current component. In alternative embodiments, applying the stator current component(s) to the rotor current command(s) may include applying only the q-component stator current component to the q-component of the rotor current command(s). In such embodiments, the stator current component(s) may include the q-component stator current component.

In further embodiments, the method 300 may include filtering and amplifying the d-component stator current component and the q-component stator current component prior to applying the d-component stator current component and the q-component stator current component to the d- and q-components of the one or more rotor current commands, respectively. In another embodiment, the method 300 may include filtering and amplifying the q-component stator current component prior to applying the q-component stator current component to the q-component of the rotor current command(s).

Referring still to FIG. 11, as shown at (306), the method 300 includes determining, via the controller, at least one voltage command for the inverter-based resource as a function of the one or more rotor current commands and the at least one stator current component. As shown at (308), the method 300 includes controlling, via the controller, the inverter-based resource, based at least in part, on the voltage command.

In certain embodiments, the method 300 may include controlling the inverter-based resource using grid-forming control. In such embodiments, determining the rotor current command(s) for the power converter may include determining the rotor current command(s) as a function of a magnetizing current command and/or a stator current feedback signal of the generator.

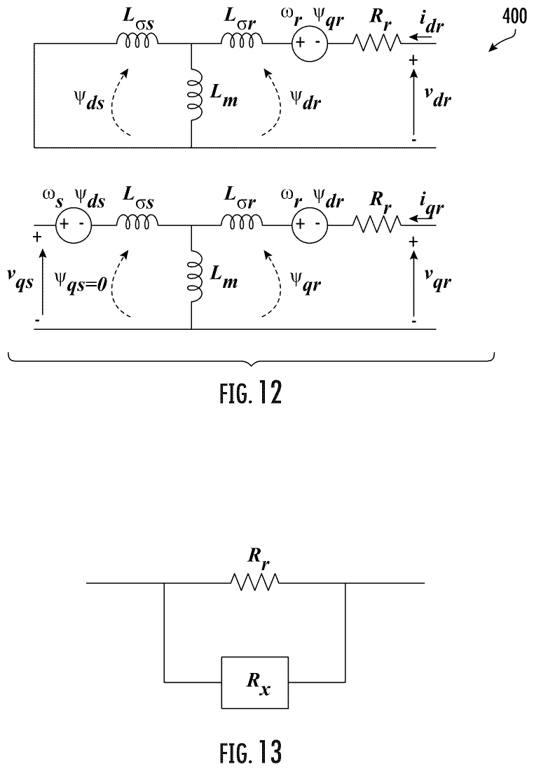

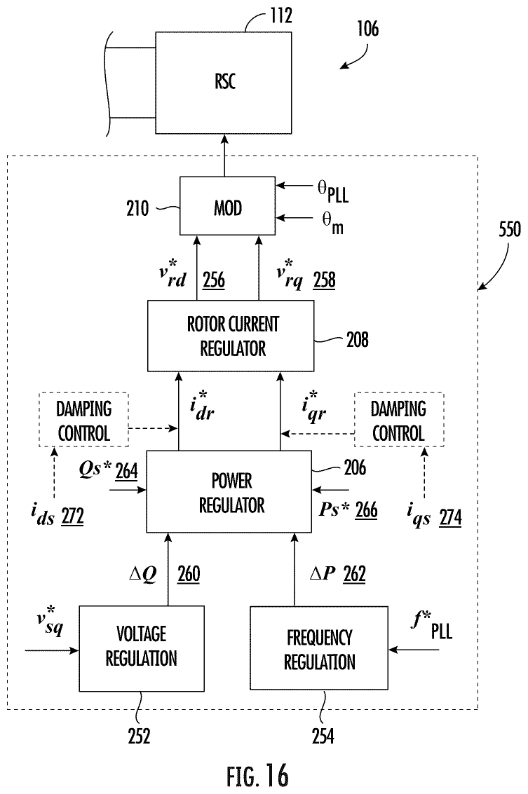

The method 300 of FIG. 11 can be better understood with reference to FIGS. 12-19. Referring particularly to FIG. 12, a schematic diagram 400 of a proposed method for mitigating sub-synchronous power oscillations in an inverter-based resource connected to an electrical grid via a series-compensated grid connection is illustrated. More specifically, analysis in the synchronous reference frame, synchronized with the grid voltage frequency, ωₛ, is provided. Further, Equations (1) and (2) provide the relationships between the voltages and the currents illustrated in FIG. 12, which can be used to calculate the d-component of rotor voltage (v_{rd}*) 256 and the q-component of rotor voltage (v_{rq}*) 258 as described herein.

$${v}_{dr} = {R}_{r} {i}_{dr} - {ω}_{r} {σL}_{r} {i}_{qr} + σ {L}_{r} \frac{d}{dt} {i}_{dr} + \frac{{L}_{m}}{{L}_{s}} \frac{d}{dt} {ψ}_{ds} \qquad Equation ( 1 )$$

$${v}_{qr} = {R}_{r} {i}_{qr} - {ω}_{r} {σL}_{r} {i}_{dr} + σ {L}_{r} \frac{d}{dt} {i}_{gr} + {ω}_{r} \frac{{L}_{m}}{{L}_{s}} {ψ}_{ds} \qquad Equation ( 2 )$$

Where Rr is the rotor resistance referred to the stator, ωr is the rotor angular frequency, σLr is the transitory inductance of the rotor, where σ is the leakage coefficient of the machine, Lm is the magnetizing inductance, Ls is the stator inductance, Lr is the rotor inductance, and ψds is the stator flux.

In particular, the equivalent rotor resistance R_{eq} at the sub-synchronous frequency becomes negative, which can inject negative damping to the system, thereby resulting is oscillation. This is primarily because of the high band-width rotor current control loop, which increases the effective rotor side resistance. Thus, to prevent the oscillation, the damping needs to be positive. Hence, the negative resistance needs to be compensated. Accordingly, as shown in FIG. 13, an approach to compensate the negative R_{eq} (Rᵣ) is by placing a parallel resistance Rₓ such that the effect of R_{eq} can be reduced and the systems overall resistance (considering stator and network resistances) becomes positive, i.e., positive damping. This relationship is also represented by Equation (3) below.

$$kf = \frac{{R}_{r}^{2}}{{R}_{r} + {R}_{x}} \qquad Equation ( 3 )$$

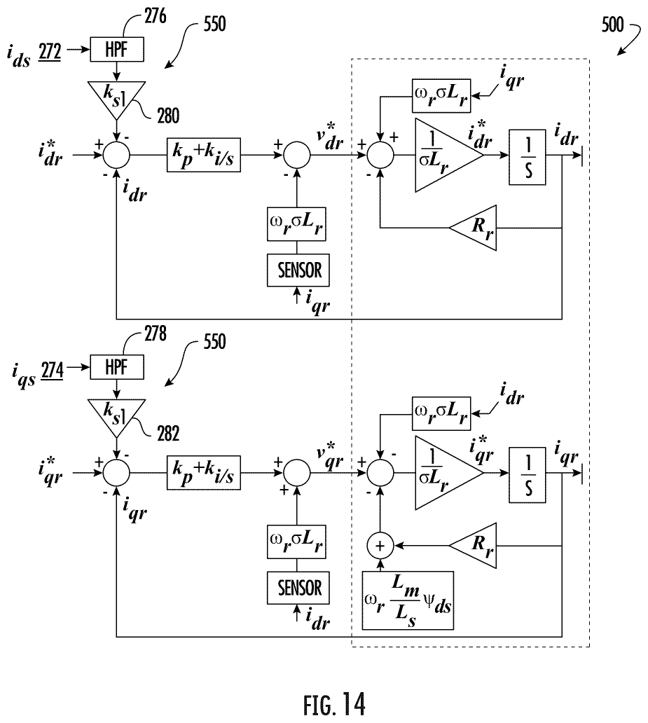

Referring now to FIGS. 14-16, schematic diagrams of an embodiment of a damping control loop 500 according to the present disclosure are illustrated, where Rᵣ is the rotor resistance referred to the stator, ωᵣ is the rotor angular frequency, σLᵣ is the transitory inductance of the rotor, where σ is the leakage coefficient of the machine, Lₘ is the magnetizing inductance, Lₛ is the stator inductance, Lᵣ is the rotor inductance, and ψ_{CR} is the stator flux, kₚ and kᵢ are the proportional and integral gains of rotor the current regulator loop, kₗₛ is the gain in the filtered stator current loops. #

In particular, as shown, damping control can be provided by adding a filtered and amplified stator current (i.e., i_{ds} and i_{qs}) with the rotor current command(s) (i.e., i_{dr}* and i_{qr}*). Considering the slow dynamics of i_{qr}* and i_{dr}* compared to the inner current loop and small kᵢ, the voltage across leakage rotor inductance can be represented by Equations (4) and (5) below:

$$σ {L}_{r} \frac{d}{dt} {i}_{qr} = - ( {R}_{r} + {k}_{p} ) {i}_{qr} - {k}_{p} {k}_{s 1} {i}_{qs} - {ω}_{r} \frac{{L}_{m}}{{L}_{s}} {ψ}_{ds} \qquad Equation ( 4 )$$

$$σ {L}_{r} \frac{d}{dt} {i}_{qr} = - ( {R}_{r} + {k}_{p} ) {i}_{qr} - {k}_{p} {k}_{s 1} {i}_{qs} \qquad Equation ( 5 )$$

The d, q components of rotor current can be represented in terms of stator current using Equations (6) and (7) below:

$${i}_{qs} = \frac{{L}_{m}}{{L}_{s}} {i}_{qr} \qquad Equation ( 6 )$$

$${i}_{ds} = \frac{{ψ}_{x}}{{L}_{s}} - \frac{{L}_{m}}{{L}_{s}} {i}_{dr} \qquad Equation ( 7 )$$

Accordingly, Equations (6) and (7) can be modified using Equations (8) and (9) below, in which the dotted circled portion represents the effective rotor resistance:

$$\begin{matrix}σ {L}_{r} \frac{d}{dt} {i}_{dr} = - ( {R}_{r} + {k}_{p} - {k}_{p} {k}_{s 1} \frac{{L}_{m}}{{L}_{s}} ) {i}_{dr} - {k}_{s 1} \frac{{ψ}_{s}}{{L}_{s}} \\ σ {L}_{r} \frac{d}{dt} {i}_{qr} = - ( {R}_{r} + {k}_{p} - {k}_{p} {k}_{s 1} \frac{{L}_{m}}{{L}_{s}} ) {i}_{qr} - {ω}_{r} \frac{{L}_{m}}{{L}_{s}} {ψ}_{ds}\end{matrix} \qquad Equations ( 8 ) and ( 9 )$$

Considering the proportional gain kp, the effective rotor resistance can be found using Equation (10) below:

$${R}_{r}^{t} = {k}_{p} + {R}_{r} \qquad Equation ( 10 )$$

Accordingly, in such embodiments, to place a parallel resistance Rₓ, the value of ks1 is calculated using Equation (11) below:

$${k}_{s 1} = \frac{{L}_{s}}{{L}_{m}} ( \frac{{R}_{r}^{2}}{{k}_{p} ( {R}_{r} + {R}_{x} )} + 1 ) \qquad Equation ( 11 )$$

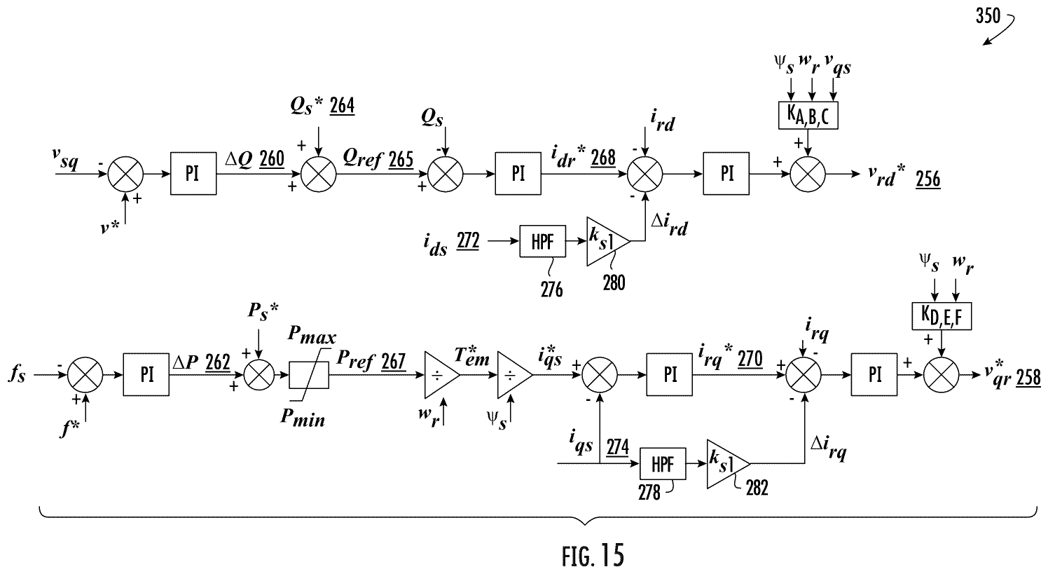

Thus, referring to FIGS. 14-16, grid-forming control schemes 550 including a voltage-frequency control strategy to operate the DFIG 102 in a grid forming mode (GFM) like that of FIGS. 9 and 10 are provided. Further, as shown, the grid-forming control scheme 550 may include many of the same components provided in FIGS. 9 and 10, with the same components having like numbering. However, as shown, the grid-forming control scheme 550 further includes the filtered and amplified d- and q-components of stator current 272, 274 (i.e., i_{ds} and i_{qs}) added with the rotor current command(s) (i.e., i_{dr}* and i_{qr}*), which is not present in FIGS. 9 and 10. Thus, the filtered and amplified d- and q-components of stator current 272, 274 provide damping control as described herein. In particular, as shown in FIGS. 14 and 15, the filtered and amplified d- and q-components of stator current 272, 274 may filtered via a high-pass filter 276, 278 or any other suitable filter followed by respective amplifiers 280, 282.

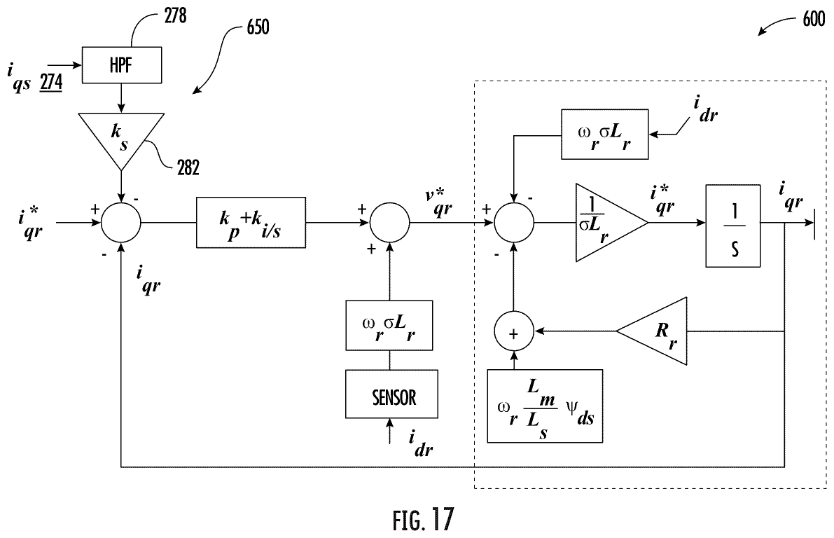

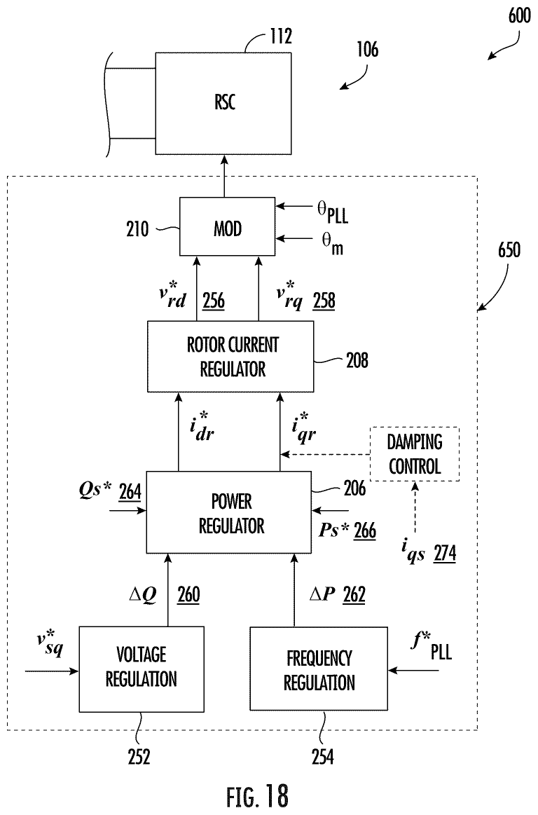

Referring now to FIGS. 17-19, schematic diagrams of another embodiment of a damping control loop 600 according to the present disclosure are illustrated, where v*, f* are the instantaneous voltage and frequency references along the direction of PCC space vector, Q_{ref}, Qₛ are the reference and feedback reactive power, P_{ref} is the active power command, T*ₑₘ is the torque command, kp and ki are the proportional and integral gains of rotor the current regulator loop, ks is the gain in the filtered q component of stator current loop, Rr is the rotor resistance referred to the stator, ωr is the rotor angular frequency, σLr is the transitory inductance of the rotor, σ is the leakage coefficient of the machine, Lₘ is the magnetizing inductance, Lₛ is the stator inductance, Lᵣ is the rotor inductance, and ψ_{ds} is the stator flux.

In particular, as shown, damping control can be provided by adding a q-component filtered and amplified stator current (i.e., i_{qs}) with the q-component rotor current command(s) (i.e., i_{qr}*). Considering the slow dynamics of i_{qr}* compared to the inner current loop and small kᵢ, the voltage across leakage rotor inductance can be represented by Equations (12), (13), and (14) below, where Rᵣ+kₚ−kₚkₛₗ(Lₘ/Lₛ) in Equation (14) represents the q-component of effective rotor resistance:

$$σ {L}_{r} \frac{d}{dt} {i}_{dr} = - ( {k}_{p} + {R}_{r} ) {i}_{qr} - {k}_{s} {i}_{qs} - {ω}_{r} \frac{{L}_{m}}{{L}_{s}} {ψ}_{ds} \qquad Equation ( 12 )$$

$${i}_{qs} = - \frac{{L}_{m}}{{L}_{s}} {i}_{qr} \qquad Equation ( 13 )$$

$$σ {L}_{r} \frac{d}{dt} {i}_{qr} = - ( {R}_{r} + {k}_{p} - {k}_{p} {k}_{s 1} \frac{{L}_{m}}{{L}_{s}} ) {i}_{qr} - {ω}_{r} \frac{{L}_{m}}{{L}_{s}} {ψ}_{ds} \qquad Equation ( 14 )$$

The reduction of the rotor equivalent resistance is achieved by introducing a loop of kₛ*i_{qs}. To place a parallel resistance of value Rₓ, the value of kₛ can be chosen from Equation (14). Furthermore, in such embodiments, the high-pass filter (HPF) can be used to filter the stator current steady-state components.

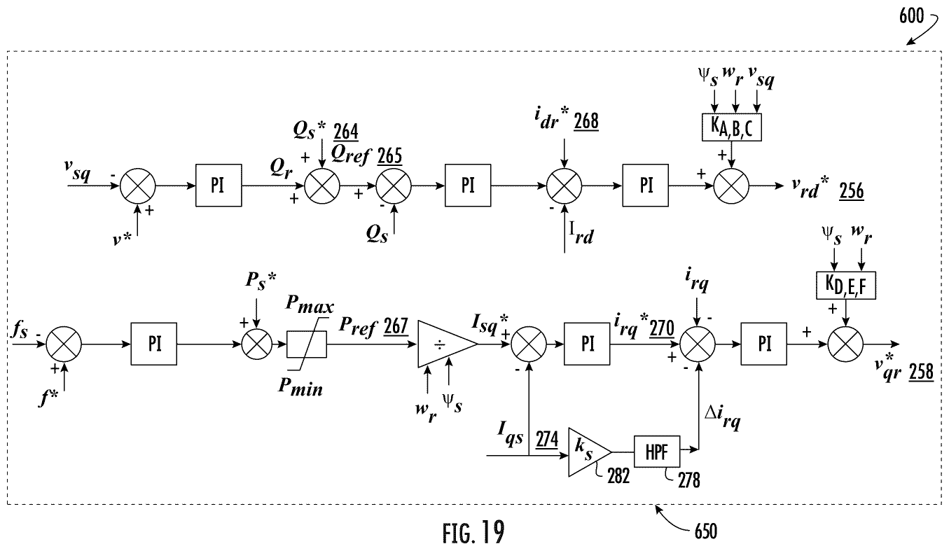

Thus, referring to FIGS. 17-19, grid-forming control schemes 650 including a voltage-frequency control strategy to operate the DFIG 102 in a grid forming mode (GFM) like that of FIGS. 9-10 and 14-16 are provided. Further, as shown, the grid-forming control scheme 650 may include many of the same components provided in FIGS. 9-10 and 14-16, with the same components having like numbering. However, as shown, the grid-forming control scheme 650 includes only the filtered and amplified q-component of stator current 274 (i.e., i_{qs}) added with the q-component rotor current command (i.e., i_{qr}*), which is different from the embodiments of FIGS. 9-10 and 14-16. Thus, the filtered and amplified q-component of stator current 274 provides damping control as described herein. In particular, as shown in FIGS. 17 and 19, the filtered and amplified q-component of stator current 274 may filtered via a high-pass filter 278 or any other suitable filter and amplified via amplifier 282.

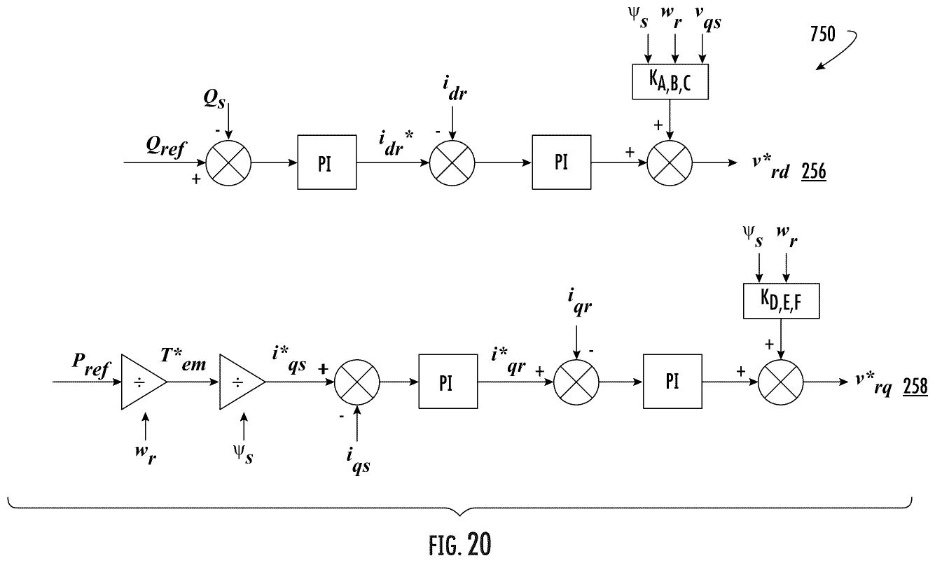

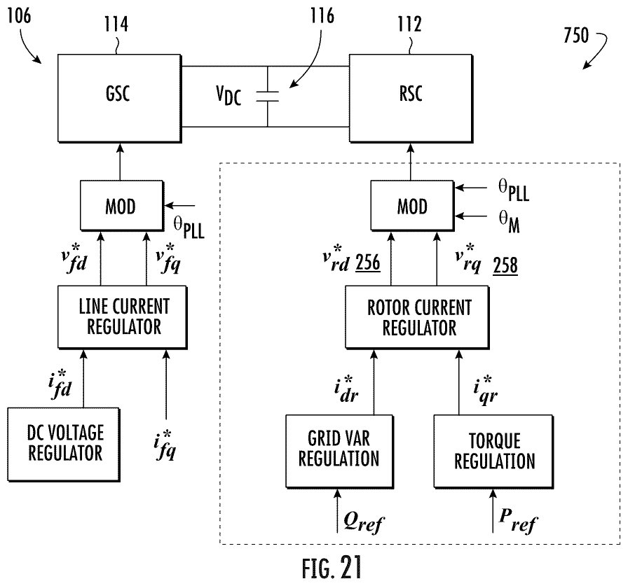

In alternative embodiments, the systems and methods described herein may include controlling the inverter-based resource using grid-following control. In particular, FIG. 20 illustrates a grid-following control loop diagram 750 for the inverter-based resource according to the present disclosure, whereas FIG. 21 illustrates the grid-following control loop diagram 750 for the inverter-based resource being applied to the power converter 106 according to the present disclosure. Thus, as shown in FIGS. 20-21, schematic diagrams of conventional grid following control 750 of an inverter-based resource are illustrated, where Q_{ref}, Qₛ are the reference and feedback reactive power, P_{ref} is the active power command, T*ₑₘ is the torque command, i_{rd}*, i_{rd} are the d components of rotor current command and feedback, i_{rq}*, i_{rq} are the q component of rotor current command and feedback, ψs is the stator flux, ωr is the rotor angular frequency, and v_{rd}*, v_{rq}* are the d, q components of rotor voltage command. In particular, as shown, the grid following mode receives a reactive power and an active power reference (Q_{ref}, P_{ref}) and regulates the reactive and active power references via various proportional integral regulators (PI) to obtain the d- and q-components of rotor voltage 256, 258 (v_{rd}*, v_{rq}*).

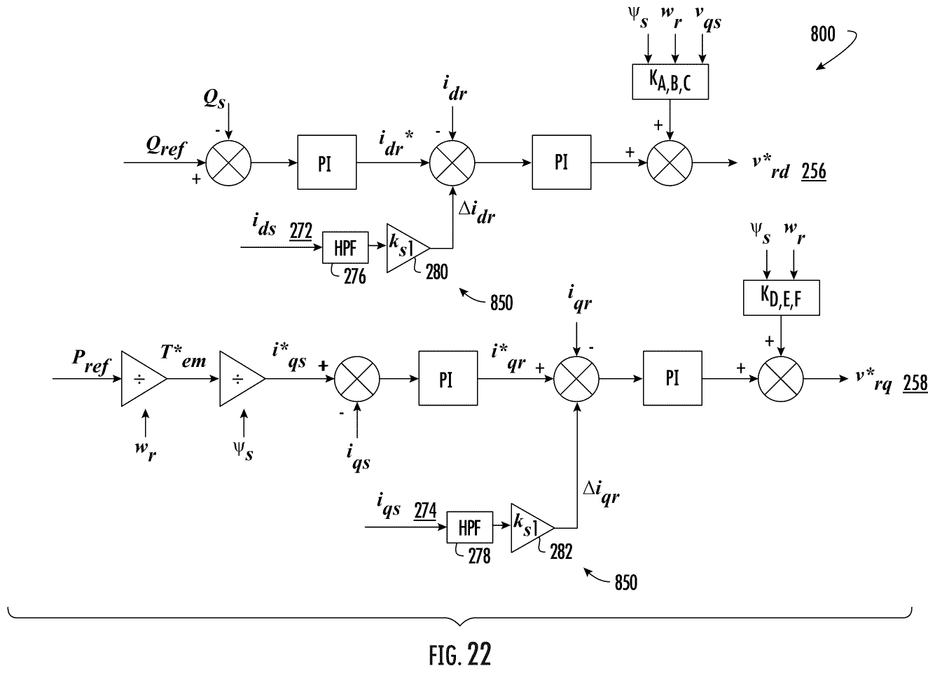

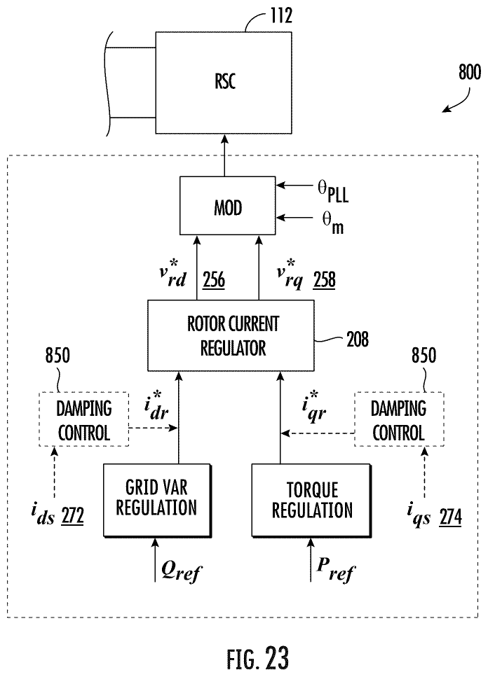

Accordingly, as shown in FIGS. 22 and 23, schematic diagrams of another embodiment of a damping control loop 700 that can be applied to a grid-following control scheme, such as grid following control 750, according to the present disclosure are illustrated. In particular, FIGS. 22 and 23 illustrate a grid-following control loop diagram 800 having damping control 850 according to the present disclosure. In particular, as shown, the damping control 850 can be provided by adding filtered and amplified d- and q-components of stator current 272, 274 (i.e., is, and i_{qs}) added with the rotor current command(s) (i.e., i_{dr}* and i_{qr}*), which is not present in FIGS. 9 and 10. Thus, the filtered and amplified d- and q-components of stator current 272, 274 provide damping control as described herein. In particular, as shown in FIG. 22, the filtered and amplified d- and q-components of stator current 272, 274 may filtered via a high-pass filter 276, 278 or any other suitable filter followed by respective amplifiers 280, 282.

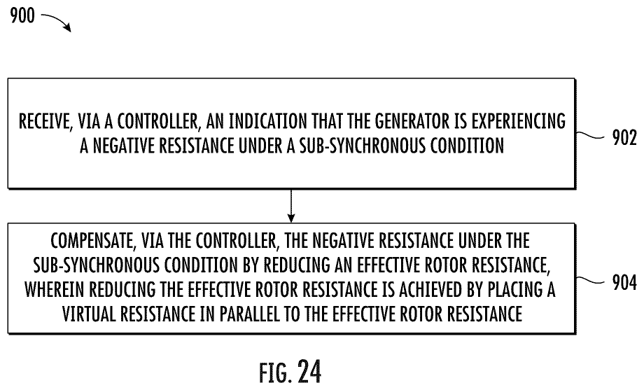

Referring now to FIG. 24, a flow diagram of one embodiment of the method 900 for mitigating sub-synchronous power oscillations in an inverter-based resource connected to an electrical grid via a series-compensated grid connection is provided. In general, the method 900 is described herein with reference to the wind turbine 10 of FIGS. 2-10. However, it should be appreciated that the disclosed method 800 may be implemented with wind turbines having any other suitable configurations. In addition, although FIG. 24 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (902), the method 900 includes receiving, via a controller, an indication that the generator is experiencing a negative resistance under a sub-synchronous condition. As shown at (904), the method 900 includes compensating, via the controller, the negative resistance under the sub-synchronous condition by reducing an effective rotor resistance, wherein reducing the effective rotor resistance is achieved by placing a virtual resistance in parallel to the effective rotor resistance.

Further aspects of the invention are provided by the subject matter of the following clauses:

Clause 1. A method for mitigating sub-synchronous power oscillations in an inverter-based resource connected to an electrical grid via a series-compensated grid connection, the inverter-based resource having a power converter and a generator, the method comprising:
determining, via a controller, one or more rotor current commands for the power converter;
applying, via a software module of the controller, at least one stator current component to the one or more rotor current commands to provide active damping to mitigate the sub-synchronous power oscillations in the inverter-based resource;
determining, via the controller, at least one voltage command for the inverter-based resource as a function of the one or more rotor current commands and the at least one stator current component; and
controlling, via the controller, the inverter-based resource, based at least in part, on the voltage command.

Clause 2. The method of clause 1, wherein applying the at least one stator current component to the one or more rotor current commands further comprises: applying a d-component stator current component and a q-component stator current component to d- and q-components of the one or more rotor current commands, respectively, the at least one stator current component comprising the d-component stator current component and the q-component stator current component.

Clause 3. The method of clause 2, further comprising filtering and amplifying the d-component stator current component and the q-component stator current component prior to applying the d-component stator current component and the q-component stator current component to the d- and q-components of the one or more rotor current commands, respectively.

Clause 4. The method of any of the preceding clauses, wherein applying the at least one stator current component to the one or more rotor current commands further comprises:
applying a q-component stator current component to a q-component of the one or more rotor current commands, the at least one stator current component comprising the q-component stator current component.

Clause 5. The method of clause 4, further comprising filtering and amplifying the q-component stator current component prior to applying the q-component stator current component to the q-component of the one or more rotor current commands.

Clause 6. The method of any of the preceding clauses, further comprising controlling the inverter-based resource using grid-forming control.

Clause 7. The method of clause 6, wherein determining the one or more rotor current commands for the power converter further comprises:
determining the one or more rotor current commands as a function of one or more power signals, wherein the one or more power signals is determined as function of at least one of one or more frequency or voltage signals.

Clause 8. The method of any of the preceding clauses, further comprising controlling the inverter-based resource using grid-following control.

Clause 9. The method of any of the preceding clauses, wherein the inverter-based resource comprises at least one of a wind turbine power system, a solar power system, an energy storage power system, or combinations thereof.

Clause 10. The method of clause 9, wherein the controller comprises at least one of a turbine controller or a converter controller of the wind turbine power system.

Clause 11. A method for mitigating sub-synchronous power oscillations in an inverter-based resource connected to an electrical grid via a series-compensated grid connection, the inverter-based resource having a power converter and a generator, the method comprising:
receiving, via a controller, an indication that the generator is experiencing a negative resistance under a sub-synchronous condition;
compensating, via the controller, the negative resistance under the sub-synchronous condition by reducing an effective rotor resistance, wherein reducing the effective rotor resistance is achieved by placing a virtual resistance in parallel to the effective rotor resistance.

Clause 12. A converter controller for mitigating sub-synchronous power oscillations in an inverter-based resource connected to an electrical grid via a series-compensated grid connection, the inverter-based resource having a power converter and a generator, the converter controller comprising:
at least one controller comprising at least one processor, the at least one processor configured to perform a plurality of operations, the plurality of operations comprising:
determining one or more rotor current commands for the power converter; applying at least one stator current component to the one or more rotor current commands to provide active damping to mitigate the sub-synchronous power oscillations in the inverter-based resource;
determining at least one voltage command for the inverter-based resource as a function of the one or more rotor current commands and the at least one stator current component; and
controlling the inverter-based resource, based at least in part, on the voltage command.

Clause 13. The converter controller of clause 12, wherein applying the at least one stator current component to the one or more rotor current commands further comprises:
applying a d-component stator current component and a q-component stator current component to d- and q-components of the one or more rotor current commands, respectively, the at least one stator current component comprising the d-component stator current component and the q-component stator current component.

Clause 14. The converter controller of clause 13, wherein the plurality of operations further comprise:
filtering and amplifying the d-component stator current component and the q-component stator current component prior to applying the d-component stator current component and the q-component stator current component to the d- and q-components of the one or more rotor current commands, respectively.

Clause 15. The converter controller of clauses 12-14, wherein applying the at least one stator current component to the one or more rotor current commands further comprises:
applying a q-component stator current component to a q-component of the one or more rotor current commands, the at least one stator current component comprising the q-component stator current component.

Clause 16. The converter controller of clause 15, wherein the plurality of operations further comprise:
filtering and amplifying the q-component stator current component prior to applying the q-component stator current component to the q-component of the one or more rotor current commands.

Clause 17. The converter controller of clauses 12-16, wherein the plurality of operations further comprise controlling the inverter-based resource using grid-forming control.

Clause 18. The converter controller of clause 17, wherein determining the one or more rotor current commands for the power converter further comprises:
determining the one or more rotor current commands as a function of one or more power signals, wherein the one or more power signals is determined as function of at least one of one or more frequency or voltage signals.

Clause 19. The converter controller of clauses 12-18, wherein the plurality of operations further comprise controlling the inverter-based resource using grid-following control.

Clause 20. The converter controller of clauses 12-19, wherein the inverter-based resource comprises at least one of a wind turbine power system, a solar power system, an energy storage power system, or combinations thereof, and wherein the controller comprises at least one of a turbine controller or a converter controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for mitigating sub-synchronous power oscillations in an inverter-based resource connected to an electrical grid via a series-compensated grid connection, the inverter-based resource having a power converter and a generator, the method comprising:
determining, via a controller, one or more rotor current commands for the power converter;
applying, via a software module of the controller, at least one stator current component to the one or more rotor current commands to provide active damping to mitigate the sub-synchronous power oscillations in the inverter-based resource;
determining, via the controller, at least one voltage command for the inverter-based resource as a function of the one or more rotor current commands and the at least one stator current component; and
controlling, via the controller, the inverter-based resource, based at least in part, on the voltage command.

2. The method of claim 1, wherein applying the at least one stator current component to the one or more rotor current commands further comprises:
applying a d-component stator current component and a q-component stator current component to d- and q-components of the one or more rotor current commands, respectively, the at least one stator current component comprising the d-component stator current component and the q-component stator current component.

3. The method of claim 2, further comprising filtering and amplifying the d-component stator current component and the q-component stator current component prior to applying the d-component stator current component and the q-component stator current component to the d- and q-components of the one or more rotor current commands, respectively.

4. The method of claim 1, wherein applying the at least one stator current component to the one or more rotor current commands further comprises:
applying a q-component stator current component to a q-component of the one or more rotor current commands, the at least one stator current component comprising the q-component stator current component.

5. The method of claim 4, further comprising filtering and amplifying the q-component stator current component prior to applying the q-component stator current component to the q-component of the one or more rotor current commands.

6. The method of claim 1, further comprising controlling the inverter-based resource using grid-forming control.

7. The method of claim 6, wherein determining the one or more rotor current commands for the power converter further comprises:
determining the one or more rotor current commands as a function of one or more power signals, wherein the one or more power signals is determined as function of at least one of one or more frequency or voltage signals.

8. The method of claim 1, further comprising controlling the inverter-based resource using grid-following control.

9. The method of claim 1, wherein the inverter-based resource comprises at least one of a wind turbine power system, a solar power system, an energy storage power system, or combinations thereof.

10. The method of claim 9, wherein the controller comprises at least one of a turbine controller or a converter controller of the wind turbine power system.

11. A method for mitigating sub-synchronous power oscillations in an inverter-based resource connected to an electrical grid via a series-compensated grid connection, the inverter-based resource having a power converter and a generator, the method comprising:
receiving, via a controller, an indication that the generator is experiencing a negative resistance under a sub-synchronous condition;
compensating, via the controller, the negative resistance under the sub-synchronous condition by reducing an effective rotor resistance, wherein reducing the effective rotor resistance is achieved by placing a virtual resistance in parallel to the effective rotor resistance.

12. A converter controller for mitigating sub-synchronous power oscillations in an inverter-based resource connected to an electrical grid via a series-compensated grid connection, the inverter-based resource having a power converter and a generator, the converter controller comprising:
at least one controller comprising at least one processor, the at least one processor configured to perform a plurality of operations, the plurality of operations comprising:
determining one or more rotor current commands for the power converter;
applying at least one stator current component to the one or more rotor current commands to provide active damping to mitigate the sub-synchronous power oscillations in the inverter-based resource;
determining at least one voltage command for the inverter-based resource as a function of the one or more rotor current commands and the at least one stator current component; and
controlling the inverter-based resource, based at least in part, on the voltage command.

13. The converter controller of claim 12, wherein applying the at least one stator current component to the one or more rotor current commands further comprises:
applying a d-component stator current component and a q-component stator current component to d- and q-components of the one or more rotor current commands, respectively, the at least one stator current component comprising the d-component stator current component and the q-component stator current component.

14. The converter controller of claim 13, wherein the plurality of operations further comprise:
filtering and amplifying the d-component stator current component and the q-component stator current component prior to applying the d-component stator current component and the q-component stator current component to the d- and q-components of the one or more rotor current commands, respectively.

15. The converter controller of claim 12, wherein applying the at least one stator current component to the one or more rotor current commands further comprises:
applying a q-component stator current component to a q-component of the one or more rotor current commands, the at least one stator current component comprising the q-component stator current component.

16. The converter controller of claim 15, wherein the plurality of operations further comprise:
filtering and amplifying the q-component stator current component prior to applying the q-component stator current component to the q-component of the one or more rotor current commands.

17. The converter controller of claim 12, wherein the plurality of operations further comprise controlling the inverter-based resource using grid-forming control.

18. The converter controller of claim 17, wherein determining the one or more rotor current commands for the power converter further comprises:
determining the one or more rotor current commands as a function of one or more power signals, wherein the one or more power signals is determined as function of at least one of one or more frequency or voltage signals.

19. The converter controller of claim 12, wherein the plurality of operations further comprise controlling the inverter-based resource using grid-following control.

20. The converter controller of claim 12, wherein the inverter-based resource comprises at least one of a wind turbine power system, a solar power system, an energy storage power system, or combinations thereof, and wherein the controller comprises at least one of a turbine controller or a converter controller.
